(19) United States
(12) Patent Application Publication
(10) Pub. No.: US 2021/0060810 A1
(43) Pub. Date: Mar. 4, 2021

(54) Gourd Cutting Apparatus and Kit and Method of Use

(71) Applicants: Trevor N. Andersen, Spanish Fork, UT (US); Tyler D. Andersen, Spanish Fork, UT (US); Dean Andersen, Spanish Fork, UT (US); Douglas Fowkes, Springville, UT (US)

(72) Inventors: Trevor N. Andersen, Spanish Fork, UT (US); Tyler D. Andersen, Spanish Fork, UT (US); Dean Andersen, Spanish Fork, UT (US); Douglas Fowkes, Springville, UT (US)

(21) Appl. No.: 17/098,346

(22) Filed: Nov. 14, 2020

Related U.S. Application Data
(60) Provisional application No. 63/085,624, filed on Sep. 30, 2020.

(51) Int. Cl. B26F 1/44; B26F 1/32

(52) U.S. Cl. CPC B26F 1/44; B26F 1/32

(57) ABSTRACT

The present invention is a gourd cutting apparatus and kit and method of use. The apparatus comprises a gourd cutter formed in a predetermined shape and adapted so as to be drive through the shell of a gourd such that a predetermined shape is removed from the gourd. The kit comprises a plurality of differently shaped gourd cutters preferably shaped such that a combination of Jack-O-Lantern faces can be created by mixing and matching the differently shaped gourd cutters and cutting predetermined shapes from a gourd such that a face of the user's liking is cut from the gourd. The Kit also preferably includes instructions having sample face designs and a package within which the cutters and instructions are provided.

### CROSS REFERENCE TO RELATED APPLICATIONS

This nonprovisional utility patent application claims the benefit under 35 USC § 119(e) of U.S. provisional application No. 63/085,624 filed Sep. 30, 2020 which is incorporated herein in its entirety by this reference.

### FIELD OF THE INVENTION

The present invention relates to apparatuses and kits for cutting and decorating gourds, and in particular, to punches used to punch predetermined shapes and patterns into pumpkins.

### BACKGROUND OF THE INVENTION

Various means are known in the art for cutting, carving, and decorating pumpkins and like gourds (see: https://www.merriam-webster.com/dictionary/gourd). However, most such means have typically included the use of sharp knives, saws, and like tools which can cause severe injury to the user or others in proximity to the user. Further, many such pumpkin cutting and carving tools are insufficient to properly cut and sever a pumpkin shell. Examples of such prior art pumpkin cutting devices are disclosed in the following list of US patents, all of which are expressly incorporated herein by reference: U.S. Pat. No. 4,296,659 to Nauman, U.S. Pat. No. 4,689,885 to Albanese, U.S. Pat. No. 4,828,114 to Bardeen, U.S. Pat. No. 5,933,968 to Solomon, U.S. Pat. No. 6,342,175 to Brown et al., and U.S. Pat. No. 6,655,032 to Thompson et al.

### SUMMARY OF THE INVENTION

The present invention is a gourd cutting apparatus and kit and method of use. The apparatus comprises a gourd cutter formed in a predetermined shape and adapted so as to be drive through the shell of a gourd such that a predetermined shape is removed from the gourd. The kit comprises a plurality of differently shaped gourd cutters preferably shaped such that a combination of Jack-O-Lantern faces can be created by mixing and matching the differently shaped gourd cutters and cutting predetermined shapes from a gourd such that a face of the user's liking is cut from the gourd. The Kit also preferably includes instructions having sample face designs and a package within which the cutters and instructions are provided.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a first trimetric view of a plurality of gourd cutters;

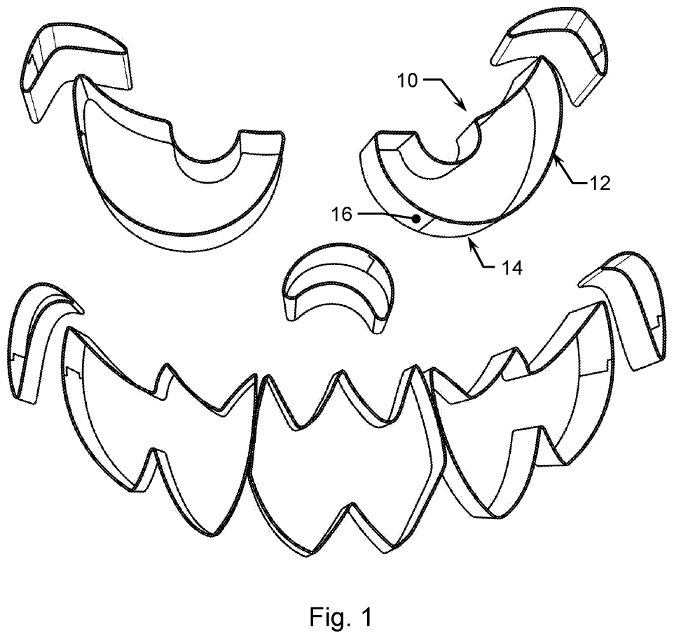

FIG. 2 is a first trimetric view of a pumpkin having a plurality of shaped pieces removed therefrom so as to for a portion of a Jack-O-Lantern face, and a gourd cutter positioned and readied for being tapped or driven into the pumpkin, and;

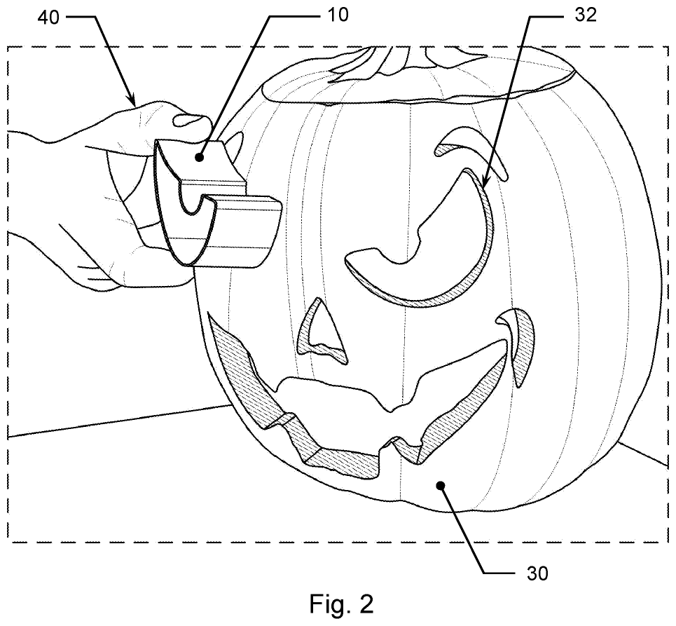

FIG. 3 is a second trimetric view of a pumpkin having a plurality of shaped pieces removed therefrom so as to for a portion of a Jack-O-Lantern face, and a gourd cutter positioned and partially driven into the pumpkin shell and a mallet near the point of impact with the gourd cutter.

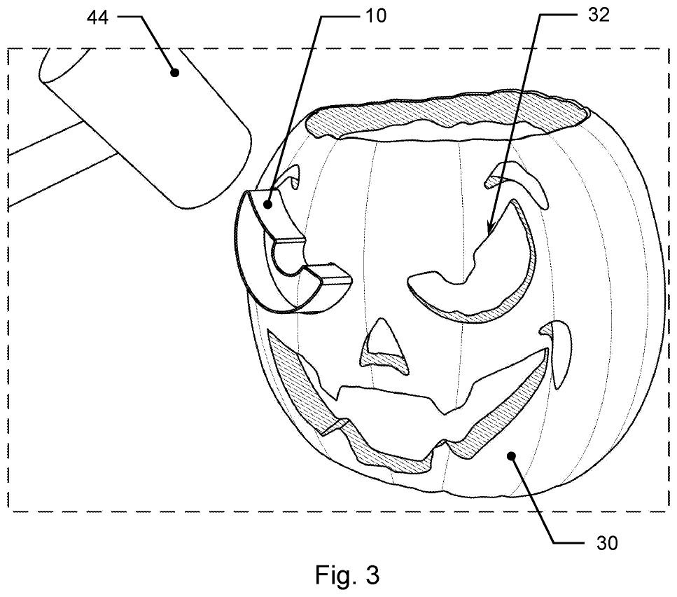

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In order to facilitate the understanding of the present invention in reviewing the drawings accompanying the specification, a feature table is provided below. It is noted that like features are like numbered throughout all of the figures.

FEATURE TABLE

| # | Feature | # | Feature |
|---|---|---|---|
| 10 | Gourd Cutter | 12 | Gourd Cutter Blunt End |
| 14 | Gourd Cutter Sharp End | 16 | Gourd Cutter Welds |
| 20 | Instructions (not shown) | 22 | Packaging (not shown) |
| 24 | Gourd Cutting Apparatus and Kit | 30 | Pumpkin |
| 32 | Pumpkin Cut Opening | 40 | Hand |
| 44 | Mallet | | |

Referring now to the drawings, a first embodiment of the gourd cutting apparatus and kit 24 comprises a plurality of gourd cutters 10, instructions 20, and packaging 22 to contain gourd cutters 10 and instructions 20. An exemplary gourd cutter 10 preferably comprises a metal strip spot-welded to itself via welds 16 at the seam of the metal strip created by positioning the two opposing ends of the strip in overlapping contact with each other, so as to form an endless metal band of a predetermined shape such as the shape of an eye, an eye brow, a nose, or a portion of a mouth. The metal strip is of a thickness (gauge) that is preferably greater than 0.01 inches, and more preferably greater than 0.012 inches, and more preferably still, at least 0.016 inches. Moreover, stiffness of gourd cutter 10 is adapted such that the gourd cutter's resistance to columnar buckling exceeds a buckling load applied to gourd cutter 10 by striking (preferably blunt end 12 of) gourd cutter 10 so as to drive gourd cutter 10 completely through the shell of a gourd such as pumpkin 30. Gourd cutter 10 further preferably includes a sharp end 14 and a blunt end 12, blunt end 12 preferably defining a rolled or curled edge of gourd cutter 10 so as to provide a strike area that is of a greater area than sharp end 14 area. The distance between sharp end 14 and blunt end 12 defines the length of cutter 10. Gourd cutter 10 has a length of preferably greater than 1.25 inches, and more preferably greater than 1.5 inches, and more preferably still, at least 2.0 inches. Moreover, gourd cutter 10 length is adapted so as to exceed the thickness of a gourd's shell, so as to completely sever a gourd's shell. Spot-welds 16 of gourd cutter 10 are preferably positioned such that a first spot-weld 16 is located on sharp end 14 of the seam of gourd cutter 10 and a second spot-weld 16 is located on blunt end 12 of the seam of gourd cutter 10, and at least one additional spot-weld 16 is located in between the first spot-weld 16 and the second spot-weld 16. Gourd cutter 10 preferably includes a plurality of spot-welds 16 located substantially equidistant between the first spot-weld 16 and the second spot-weld 16, and more preferably still, gourd cutter 10 includes at least three spot-welds 16 located substantially equidistant between the first spot-weld 16 and the second spot-weld 16. Moreover, shear strength of the spot-welded seam (the measure of resistance to separation of the seam) exceeds a shear load applied to gourd cutter 10 from striking gourd cutter 10 so as to drive gourd cutter 10 completely through the shell of a gourd such as pumpkin 30.

In practice, a user positions gourd cutter 10 at a location of choosing on an outer surface of a gourd such as pumpkin 30, with sharp end 14 of gourd cutter 10 in contact with the outer surface of pumpkin 30. The user then strikes blunt end 12 of gourd cutter 10 with a mallet 44 so as to drive gourd cutter 10 a distance into the shell of pumpkin 30 without gourd cutter 10 buckling or separating. The step of striking gourd cutter 10 into pumpkin 30 with a mallet 44 is repeated until sharp end 14 of gourd cutter 10 is driven past the inner surface of the shell of pumpkin 30 and such that a predetermined shaped piece of shell of pumpkin 30 is completely severed from pumpkin 30. The process of positioning gourd cutter 10 and tapping or driving gourd cutter 10 through the shell of pumpkin 30 is repeated in different locations on the shell of pumpkin 30, preferably with differently shaped gourd cutters 10, until a desire pattern (e.g. a Jack-O-Lantern face) is created. The above described method of cutting and creating a Jack-O-Lantern or like pattern or image is substantially superior to prior art methods due to the reduced risk of cuts or other injuries to a user or to others in near proximity to the user.

In an alternate embodiment, rather than being constructed of a metal strip, gourd cutter 10 defines a single-piece (molded) plastic apparatus. Further disclosure is provided in Appendix-A of this application which discloses an embodiment of the invention as it recently became available on Amazon, Inc's website (see: https://www.amazon.com/Pumpkin-Punches-Carving-Jack-Lantern/dp/B07588LFBL).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A gourd cutting apparatus comprising a metal strip having a predetermined shape and a first end thereof connected to a second end thereof by a welded seam, wherein said gourd cutting apparatus includes a sharp end, a blunt end, a thickness, and a length, and wherein said thickness is at least 0.01 inches, and wherein said length is at least 1.25 inches, and wherein said welded seam defines a seam having a spot weld on a first seam end and on a second seam end and having a plurality of spot welds positioned substantially equidistantly therebetween.

2. The gourd cutting apparatus of claim 1 wherein said thickness defines at least one thickness of greater than 0.012 inches and greater than 0.016 inches.

3. The gourd cutting apparatus of claim 1 wherein said length defines at least one length of greater than 1.5 inches and greater than 2.0 inches.

4. The gourd cutting apparatus of claim 1 wherein said welded seam has at least five spot welds positioned thereon.

5. The gourd cutting apparatus of claim 1 wherein said predetermined shape defines the shape of at least one of an eye, an eye brow, a nose, and at least a portion of a mouth.

6. The gourd cutting apparatus of claim 1 wherein said gourd cutting apparatus is adapted so as to be driven completely through the shell of a gourd without said gourd cutting apparatus buckling or separating and such that a predetermined shaped piece of gourd shell is completely severed from said shell of said gourd.

7. The gourd cutting apparatus of claim 1 wherein said thickness defines a thickness of greater than 0.016 inches, and wherein said length defines a length of greater than 2.0 inches, and wherein said welded seam has at least five spot welds positioned thereon, and wherein said predetermined shape defines the shape of at least one of an eye, an eye brow, a nose, and at least a portion of a mouth.

8. The gourd cutting apparatus of claim 7 wherein said gourd cutting apparatus is adapted so as to be driven completely through the shell of a gourd without said gourd cutting apparatus buckling or separating and such that a predetermined shaped piece of gourd shell is completely severed from said shell of said gourd.

9. A gourd cutting kit comprising a plurality of gourd cutting apparatuses contained within a package, wherein each of said gourd cutting apparatuses defines a metal strip having a predetermined shape and a first end thereof connected to a second end thereof by a welded seam, wherein said gourd cutting apparatus includes a sharp end, a blunt end, a thickness, and a length, and wherein said thickness is at least 0.01 inches, and wherein said length is at least 1.25 inches, and wherein said welded seam defines a seam having a spot weld on a first seam end and on a second seam end and having a plurality of spot welds positioned substantially equidistantly therebetween, and wherein at least one of said gourd cutting apparatuses has a predetermined shape that differs from another of said gourd cutting apparatuses.

10. The gourd cutting kit of claim 9 wherein said kit includes instructions.

11. The gourd cutting kit of claim 9 wherein said kit includes at least 10 gourd cutting apparatuses.

12. The gourd cutting kit of claim 9 wherein said predetermined shapes of said gourd cutting apparatuses includes the shapes of at least one eye, at least one eye brow, at least one nose, and at least a portion of a mouth.

13. The gourd cutting kit of claim 9 wherein said gourd cutting apparatuses are adapted so as to be driven completely through the shell of a gourd without said gourd cutting apparatus buckling or separating and such that a predetermined shaped piece of gourd shell is completely severed from said shell of said gourd.

14. The gourd cutting kit of claim 9 wherein said thickness defines a thickness of greater than 0.016 inches, and wherein said length defines a length of greater than 2.0 inches, and wherein said welded seam has at least five spot welds positioned thereon.

15. The gourd cutting kit of claim 14 wherein said gourd cutting apparatus is adapted so as to be driven completely through the shell of a gourd without said gourd cutting apparatus buckling or separating and such that a predetermined shaped piece of gourd shell is completely severed from said shell of said gourd.

16. A method of cutting a gourd comprising providing a gourd cutting apparatus, positioning said gourd cutting apparatus in contact with an outer surface of a shell of a gourd, and striking said gourd cutting apparatus at least once so as to cause said gourd cutting apparatus to be driven completely through said shell of said gourd without said gourd cutting apparatus buckling or separating and such that a predetermined shaped piece of gourd shell is completely severed from said shell of said gourd.

17. The method of claim 16 wherein said gourd cutting apparatus defines a metal strip having a predetermined shape and a first end thereof connected to a second end thereof by a welded seam, wherein said gourd cutting apparatus includes a sharp end, a blunt end, a thickness, and a length, and wherein said thickness is at least 0.01 inches, and wherein said length is at least 1.25 inches, and wherein said welded seam defines a seam having a spot weld on a first seam end and on a second seam end and having a plurality of spot welds positioned substantially equidistantly therebetween.

18. The method of claim 16 wherein said predetermined shaped piece of gourd shell defines the shape of at least one of an eye, an eye brow, a nose, and at least a portion of a mouth.

19. The method of claim 17 wherein said thickness defines a thickness of greater than 0.016 inches, and wherein said length defines a length of greater than 2.0 inches, and wherein said welded seam has at least five spot welds positioned thereon.

20. The method of claim 16 wherein said gourd cutting apparatus is struck with a mallet.
